(19) United States
(12) Patent Application Publication
(10) Pub. No.: US 2021/0318193 A1
(43) Pub. Date: Oct. 14, 2021

(54) METHOD, SYSTEM, COMPUTER APPARATUS, AND STORAGE MEDIUM FOR INSPECTING OPERATION PERIOD OF VALVE BOX

(71) Applicant: Haimo Pandora Data Technology (Shenzhen) Co., Ltd., Shenzhen (CN)

(72) Inventors: Hongjie Yuan, Shenzhen (CN); Yunzhou Zhu, Shenzhen (CN); Xiaofang Li, Shenzhen (CN); Yixin Lu, Shenzhen (CN); He Wang, Shenzhen (CN); Kai Liu, Shenzhen (CN); Donglin Yang, Shenzhen (CN); Jianfeng Zhou, Shenzhen (CN)

(21) Appl. No.: 16/932,708

(22) Filed: Jul. 18, 2020

(30) Foreign Application Priority Data
Apr. 9, 2020 (CN) 202010274529.8

(51) Int. Cl. G01L 19/00; G01L 1/22; F04B 7/00; F04B 53/10; F04B 51/00

(52) U.S. Cl. CPC G01L 19/0092; G01L 1/22; E21B 43/2607; F04B 53/109; F04B 51/00; F04B 7/0015

(57) ABSTRACT

The disclosure relates to a method, a system, a computer apparatus, and a storage medium for inspecting an operation period of a valve box. The method for inspecting the operation period of the valve box includes at least one of a pressure of the liquid outlet, a stress of the housing, and an acceleration of the housing is acquired. Single operation periods of the valve box are calculated according to at least one of the pressure of the liquid outlet, the stress of the housing, and the acceleration of the housing. Finally, the single operation periods of the valve box are accumulated to obtain a total operation period of the valve box.

### CROSS-REFERENCE TO RELATED APPLICATION

This application claims the benefit of Chinese Patent Application No. 2020102745298, filed on Apr. 9, 2020, the entire content of which is incorporated herein by reference in its entirety.

### FIELD

The present disclosure relates to a technical field of a valve box of a hydraulic end of a fracturing pump.

### BACKGROUND

Fracturing pump is one of the key devices in petroleum industry. Fracturing pump generally consists of a power end and a hydraulic end. The hydraulic end is used to complete suction of low-pressure liquid and discharge of high-pressure liquid.

In the conventional technology, the hydraulic end generally includes a valve box and a plunger inserted into the valve box, and reciprocating motion of the plunger realizes cyclic pressurization and depressurization process of the liquid.

### SUMMARY

Based on this, it is necessary to provide a method, a system, a computer apparatus and a storage medium for inspecting an operation period of a valve box in view of the lack of effective monitoring of the operation period of the valve box in the conventional technology.

The valve box includes a housing provided with a liquid outlet. The method for inspecting the operation period of the valve box includes: at least one of a pressure of the liquid outlet, a stress of the housing, and an acceleration of the housing is acquired. Single operation periods of the valve box are calculated according to at least one of the pressure of the liquid outlet, the stress of the housing, and the acceleration of the housing. The single operation periods of the valve box are accumulated to obtain a total operation period of the valve box.

A system for inspecting an operation period of a valve box includes: the valve box including a housing provided with a liquid outlet for discharging liquid and at least one of a pressure sensor, a strain gauge sensor, and an acceleration sensor. The pressure sensor is provided at the liquid outlet to acquire pressure of the liquid outlet. The strain gauge sensor is connected to the housing to acquire stress of the housing. The acceleration sensor is connected to the housing to acquire acceleration of the housing. A computer apparatus is connected to at least one of the pressure sensor, the strain gauge sensor, and the acceleration sensor to perform the steps of the methods according to the embodiments described above.

A computer apparatus includes a memory and a processor. The memory stores a computer program. The processor implements steps of methods according to the embodiments described above when executing the computer program.

A computer readable storage medium stores a computer program. Steps of methods according to the embodiments described above are implemented when the computer program is executed by a processor.

The method for inspecting the operation period of the valve box includes: at least one of the pressure of the liquid outlet, the stress of the housing, and the acceleration of the housing is acquired. The single operation periods of the valve box are calculated according to at least one of the pressure of the liquid outlet, the stress of the housing, and the acceleration of the housing. Finally, the single operation periods of the valve box are accumulated to obtain a total operation period of the valve box. In this way, the method for inspecting the operation period of the valve box can inspect the operation period of the valve box, facilitating scientific use of the valve box.

### BRIEF DESCRIPTION OF THE DRAWINGS

To illustrate to the embodiments of the present disclosure or in the prior art more clearly, the accompanying drawings for describing the embodiments or the prior art are introduced briefly in the following. Apparently, the accompanying drawings in the following description are only some embodiments of the present disclosure.

FIG. 1 is a cross-sectional structure view of a valve box according to an embodiment of the present disclosure;

FIG. 2 is a cross-sectional view along B-B line of the valve box of FIG. 1;

FIG. 3 is an enlarged view of part A of the cross-sectional view of FIG. 2;

FIG. 4 is an enlarged view of a fixing plate member of the view of FIG. 3;

FIG. 5 is a flow chart of a method for inspecting an operation period of a valve box according to an embodiment of the present disclosure;

FIG. 6 is a flow chart of a method for inspecting an operation period of a valve box according to another embodiment of the present disclosure;

FIG. 7 is a partial flow chart of a method for inspecting an operation period of a valve box according to an embodiment of the present disclosure;

FIG. 8 is a view of a pressure profile according to an embodiment of the present disclosure;

FIG. 9 is a partial flow chart of a method for inspecting an operation period of a valve box according to another embodiment of the present disclosure;

FIG. 10 is a flow chart of a method for inspecting an operation period of a valve box according to another embodiment of the present disclosure;

FIG. 11 is a partial flow chart of a method for inspecting an operation period of a valve box according to another embodiment of the present disclosure;

FIG. 12 is a view of a correspondence relationship between amplitudes and frequencies according to an embodiment of the present disclosure;

FIG. 13 is a partial flow chart of a method for inspecting an operation period of a valve box according to another embodiment of the present disclosure;

FIG. 14 is a partial flow chart of a method for inspecting an operation period of a valve box according to another embodiment of the present disclosure;

FIG. 15 is a view of a shift relationship between a first stress data set and a second stress data according to an embodiment of the present disclosure;

FIG. 16 is a flow chart of a method for inspecting an operation period of a valve box according to another embodiment of the present disclosure; and

FIG. 17 is a partial flow chart of a method for inspecting an operation period of a valve box according to another embodiment of the present disclosure.

The meanings represented by the reference numerals of the drawings are as follows:
10 valve box
110 housing
112 liquid outlet
114 connecting hole
124 strain gauge sensor
126 acceleration sensor
130 fixing plate member
132 silica gel

### DETAILED DESCRIPTION OF THE EMBODIMENTS

In the process of realizing the conventional technology, the inventors found that the conventional technology lacks the effective monitoring of the operation period of the valve box, which is unfavorable for a scientific use of the valve box.

In order to make the above-mentioned purposes, features, and advantages of the present disclosure more apparent and understandable, a detailed description of the specific embodiments of the present disclosure is given below in conjunction with the accompanying drawings. Many specific details are set forth in the following description to facilitate a full understanding of the present disclosure.

The serial numbers assigned to parts in this article, such as “first”, “second”, etc., are used only to distinguish between the objects described and do not have any sequential or technical meaning. In this disclosure, however, the terms “connection” and “couple”, unless otherwise specified, include both direct and indirect connections (couple). In the description of this disclosure, it is to be understood that the terms “top”, “bottom”, “front”, “back”, “left”, “right”, “vertical”, “horizontal”, “top”, “bottom”, “inside”, “outside”, “clockwise”, “counterclockwise”, etc., indicate an orientation or position relationship based on the orientation or position relationship shown in the accompanying drawings and are intended only to facilitate the description of this application and simplify the description, and do not indicate or imply that the device or element referred to must have a particular orientation, be constructed and operated in a particular orientation, and therefore cannot be understood as a limitation of this disclosure.

For the purposes of this disclosure, unless otherwise expressly provided and qualified, the first feature being “above” or “below” a second feature may be that the first feature is in direct contact with the second feature, or that the first and second features may be in indirect contact through an intermediary. Moreover, the first feature is “over”, “on”, and “on” the second feature could be that the first feature is directly or obliquely above the second feature, or simply indicates that the first feature is higher in level than the second feature. The first feature being “below”, “under”, and “beneath” the second feature, could be either directly or diagonally below the second feature, or simply indicates that the first feature is lower in level than the second feature.

A fracturing pump is typically composed of a power end and a hydraulic end, and the power end is mainly configured to transmit power. The hydraulic end is a key part of the fracturing pump, which is configured to complete suction of low pressure liquid and discharge of high pressure liquid. In some embodiments, the hydraulic end includes a valve box and a plunger inserted into the valve box. A cyclic pressurization and depressurization process of the liquid is achieved through reciprocating motion of the plunger. During the reciprocating motion of the plunger, the housing of the valve box generates periodic deformation and vibration due to stress.

The present disclosure provides a method, a system, a computer apparatus, and a storage medium for inspecting an operation period of the valve box 10. The operation period of the valve box 10 can be inspected according to characteristics of the hydraulic end in operation.

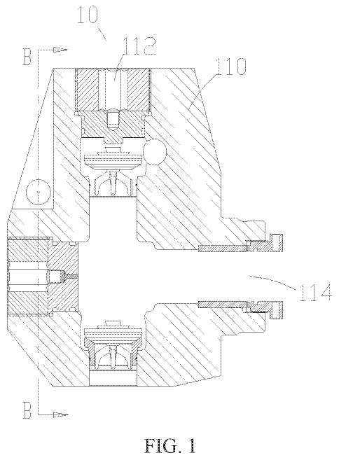

As shown in FIG. 1, in some embodiments, the valve box 10 includes a housing 110. The housing 110 of the valve box 10 is provided with a liquid outlet 112 for discharging liquid, and a connecting hole 114 for connecting with the plunger. The plunger can be inserted into the valve box 10 through the connecting hole 114 to pressurize and depressurize the liquid in the valve box 10 by the reciprocating motion. High-pressure liquid is discharged from the liquid outlet 112.

In the present disclosure, the liquid outlet 112 is provided with a pressure sensor through which the pressure of the liquid outlet 112 can be acquired. For example, in some specific embodiments, a three-way pipe member can be provided at the liquid outlet 112 of the valve box 10. The three-way pipe member is a pipe member including three through holes communicating with each other. Here, a through hole of the three-way pipe member may be connected to the liquid outlet 112 for acquiring the high-pressure liquid discharged from the valve box 10. Another through hole of the three-way pipe member may be connected to a pipe for discharging the liquid. A third through hole of the three-way pipe member may be connected to the pressure sensor, and the pressure sensor acquires the pressure of the liquid outlet 112.

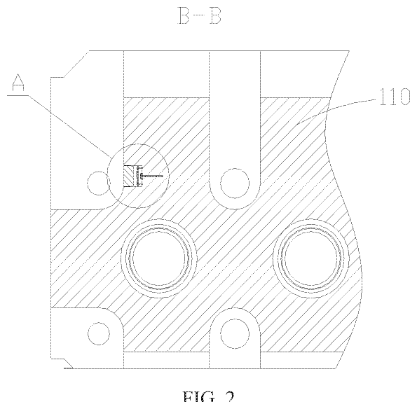

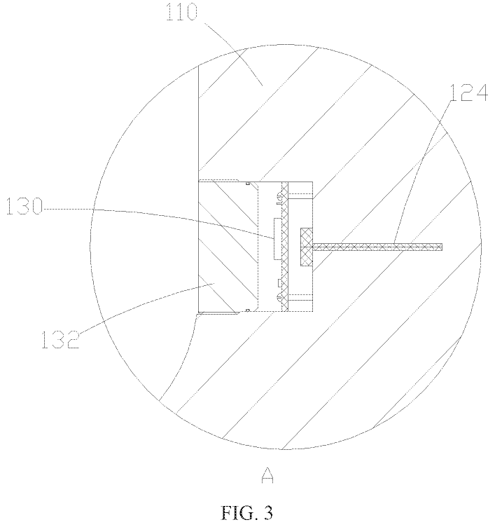

FIG. 2 is a cross-sectional view along B-B line of the valve box 10 of FIG. 1. FIG. 3 is an enlarged view of part A of FIG. 2. As shown in FIGS. 2 and 3, in some embodiments, a strain gauge sensor 124 is embedded in the housing 110 of the valve box 10. Thus, when the housing 110 of the valve box 10 generates periodic deformation during the operation of the valve box 10, the strain gauge sensor 124 can inspect periodic stress changes. In other embodiments, the strain gauge sensor 124 may also be attached to a surface of the housing 110 of the valve box 10 to inspect periodic stress changes of the housing 110. Here, the strain gauge sensor 124 may be attached to an outer surface of the housing 110 of the valve box 10.

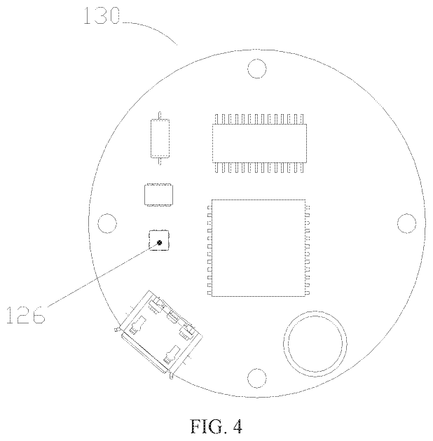

In some embodiments, as shown in FIG. 3, a hollow is provided in the housing 110 of the valve box 10. The strain gauge sensor 124 may be located in the hollow and embedded in the housing 110 of the valve box 10. At the same time, a fixing plate member 130 may be provided in the hollow and be connected to the housing 110. FIG. 4 is an enlarged view of the fixing plate member 130 of FIG. 3. In some embodiments, an acceleration sensor 126 is provided on the fixing plate member 130. Thus, when the housing 110 of the valve box 10 vibrates during the operation of the valve box 10, the acceleration sensor 126 can inspect periodic acceleration changes. In other embodiments, the acceleration sensor 126 may also be attached to the surface of the housing 110 of the valve box 10 to inspect the periodic acceleration changes of the housing 10. Here, the acceleration sensor 126 may be attached to the outer surface of the housing 110 of the valve box 10.

In some embodiments, as shown in FIG. 4, a silica gel 132 may also be used to fill an opening of the hollow when the fixing plate member 130 is disposed within the hollow. At this time, the fixing plate member 130 is located in a chamber formed by the silica gel 132 and the housing 110. Thus, the acceleration sensor 126 located on the fixing plate member 130 can be protected by soft feature of the silica gel 132.

Hereinafter, the method for inspecting the operation period of the valve box of the present disclosure will be described with reference to the accompanying drawings.

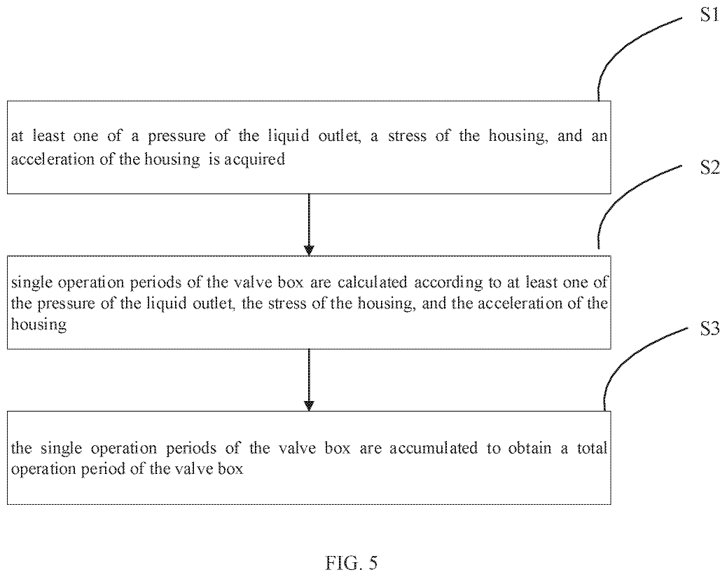

In some embodiments, the method for inspecting the operation period of the valve box of the present disclosure is applied to the valve box 10 in the above-described embodiment. As shown in FIG. 5, the method for inspecting the operation period of the valve box 10 of the present disclosure includes the following steps:

At step S1: at least one of a pressure of the liquid outlet 112, a stress of the housing 110, and an acceleration of the housing 110 is acquired.

In some embodiments, the pressure of the liquid outlet 112 can be acquired by a pressure sensor provided at the liquid outlet 112. The stress of the housing 110 can be acquired by a strain gauge sensor 124 embedded in the housing 110. The acceleration of the housing 110 can be acquired by an acceleration sensor 126 embedded in the housing 110. Here, the embedding means that the strain gauge sensor 124 or the acceleration sensor 126 is embedded inside the housing 110 by embedding.

In some embodiments of the present disclosure, the method for inspecting the operation period of the valve box 10 of the present disclosure may acquire at least one of the pressure of the liquid outlet 112, the stress of the housing 110, and the acceleration of the housing 110. The at least one here refers to any one, any two, or any three of the pressure of the liquid outlet 112, the stress of the housing 110, and the acceleration of the housing 110.

At step S2: single operation periods of the valve box 10 are calculated according to at least one of the pressure of the liquid outlet 112, the stress of the housing 110, and the acceleration of the housing 110.

The single operation periods of the valve box 10 are calculated according to any one, any two, or any three of the pressure of the liquid outlet 112, the stress of the housing 110, and the acceleration of the housing 110 acquired in step S1. The single operation period of the valve box 10 refers to the length of time from the start operation time of the valve box 10 to the stop operation time of the valve box 10 during any one operation of the valve box 10.

At step S3: the single operation periods of the valve box 10 are accumulated to obtain a total operation period of the valve box 10.

Each time the valve box 10 is operated, its operation period is inspected to obtain the single operation period. Therefore, the total operation period of the valve box 10 can be obtained by accumulating the single operation periods corresponding to one valve box 10.

The operation period of the valve box 10 can be inspected by the method for inspecting the operation period of the valve box 10. Thus, beneficial effects that can be achieved include, but are not limited to, the operation period of the valve box 10 is inspected in real time to provide a theoretical basis for calculating a service life of the valve box 10. A remaining life of the valve box 10 is predicted in real time facilitating replacement of the valve box 10 in time before the valve box 10 is damaged. A use condition of the valve box 10 is inspected in real time to make a data reserve for increasing the service life of the valve box 10.

Next, the method for inspecting the operation period of the valve box 10 of the present disclosure will be described in detail based on the pressure of the liquid outlet 112, the stress of the housing 110, and the acceleration of the housing 110, respectively.

The operation period of the valve box 10 is inspected according to the pressure of the liquid outlet 112.

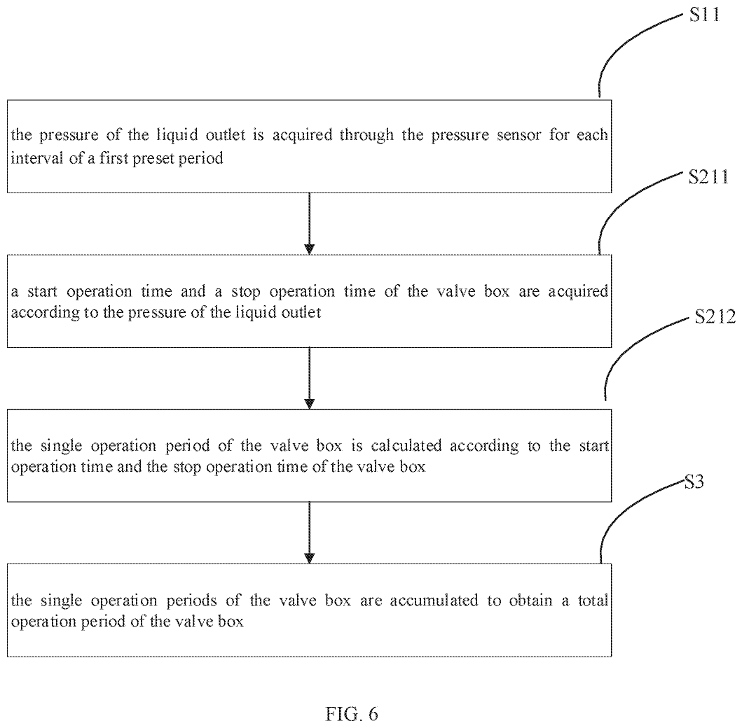

In some embodiments, as shown in FIG. 6, step S1 of the method for inspecting the operation period of the valve box 10 described above includes:

At step S11, the pressure of the liquid outlet 112 is acquired through the pressure sensor for each interval of a first preset period.

The first preset period here refers to a preset length of time. For example, the first preset period may be 20 seconds, 30 seconds, or 40 seconds. The “first” herein is only used to distinguish from the second preset period described below, without other meaning.

In some embodiments, the first preset period may be 30 seconds. At this time, the step S11 is acquiring the pressure of the liquid outlet 112 through the pressure sensor every 30 seconds.

Based on the above step S11, step S2 may include:

At step S211: a start operation time and a stop operation time of the valve box 10 are acquired according to the pressure of the liquid outlet 112.

At step S212: the single operation period of the valve box 10 is calculated according to the start operation time and the stop operation time of the valve box 10.

Here, the single operation period of the valve box 10 is the length of time from the start operation time to the stop operation time.

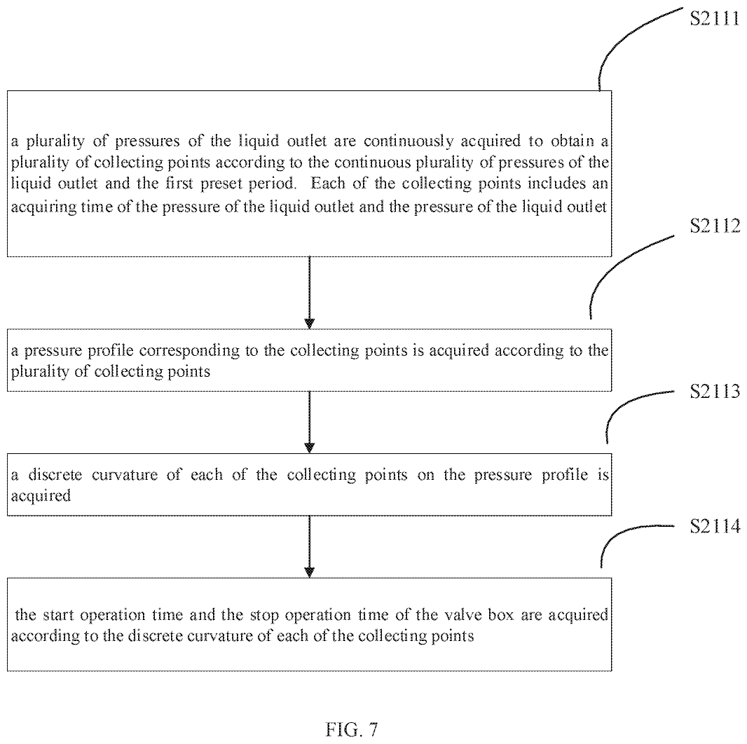

In some embodiments, as shown in FIG. 7, the step S211 may include:

At step S2111: a plurality of pressures of the liquid outlet 112 are continuously acquired to obtain a plurality of collecting points according to the continuous plurality of pressures of the liquid outlet 112 and the first preset period. Each of the collecting points includes an acquiring time of the pressure of the liquid outlet 112 and the pressure of the liquid outlet 112.

“The plurality of” in the plurality of pressures of liquid outlet 112 is a limit to the pressure of the liquid outlet 112. “The plurality of” herein refers to an integer of three or more. Here, continuously acquiring the plurality of pressures of liquid outlet 112 means acquiring the pressure of the liquid outlets 112 once for each interval of the first preset period according to the first preset period, obtaining a plurality of pressure data. At this time, each pressure corresponds to one time, and a time difference between two adjacent pressures is the first preset period.

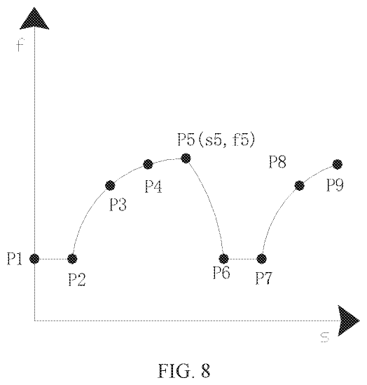

Here, the plurality of collecting points P(sᵢ, fᵢ) can be obtained according to the plurality of pressures and the first preset period between two adjacent pressures. Each of the collecting points P includes the pressure fᵢ of the liquid outlet 112 and the acquiring time sᵢ of the pressure. In some specific embodiments, the images of the plurality of collecting points in the time-pressure coordinate axis are shown in FIG. 8.

At step S2112: a pressure profile corresponding to the collecting points is acquired according to the plurality of collecting points.

As shown in FIG. 8, the pressure profile corresponding to the plurality of collecting points can be obtained by connecting the plurality of collecting points using a curve.

At step S2113: a discrete curvature of each of the collecting points on the pressure profile is acquired.

After the pressure profile is drawn, the discrete curvature of each of the collecting points on the pressure profile is calculated.

At step S2114: the start operation time and the stop operation time of the valve box 10 are acquired according to the discrete curvature of each of the collecting points.

After calculating the discrete curvature of each of the collecting points, the start operation time and the stop operation time of the valve box 10 can be determined according to the discrete curvature of each of the collecting points.

In some specific embodiments, the step S2113 described above specifically includes:

The discrete curvature of each of the collecting points on the pressure profile is calculated according to a formula

$${K}_{i} = \frac{Δ {θ}_{i}}{Δ {L}_{i}} .$$

In the above formula, Kᵢ is the discrete curvature of the i-th collecting point.

$$Δ {θ}_{i} = arc tan ( \frac{( {f}_{i} - {f}_{i + 2} ) ( {s}_{i} - {s}_{i - 2} ) - ( {f}_{i} - {f}_{i - 2} ) ( {s}_{i} - {s}_{i + 2} )}{1 + ( {s}_{i} - {s}_{i - 2} ) ( {s}_{i} - {s}_{i + 2} )} )$$

$$Δ {L}_{i} = \sqrt{{( {s}_{i + 1} - {s}_{i} )}^{2} + {( {f}_{i + 1} - {f}_{i} )}^{2}} + \sqrt{{( {s}_{i} - {s}_{i - 1} )}^{2} + {( {f}_{i} - {f}_{i - 1} )}^{2}}$$

fᵢ is the pressure of the liquid outlet 112 of the i-th collecting point. sᵢ is the acquiring time of the pressure of the liquid outlet 112 of the i-th collecting point.

More specifically, when the discrete curvature of the collecting point P5 in FIG. 8 is to be calculated, the discrete curvature of the collecting point P5 can be calculated by a formula

$${K}_{5} = \frac{Δ {θ}_{5}}{Δ {L}_{5}} .$$

At this time,

$$Δ {θ}_{5} = arctan ( \frac{( {f}_{5} - {f}_{7} ) ( {s}_{5} - {s}_{3} ) - ( {f}_{5} - {f}_{3} ) ( {s}_{5} - {s}_{7} )}{1 + ( {s}_{5} - {s}_{3} ) ( {s}_{5} - {s}_{7} )} )$$

in the above formula, f₅ is the pressure of the liquid outlet 112 of the collecting point P5; s₅ is the acquiring time of the pressure of the collecting point P5; f₇ is the pressure of the liquid outlet 112 of the collecting point P7; s₇ is the acquiring time of the pressure of the collecting point P7; f₃ is the pressure of the liquid outlet 112 of the collecting point P3; s₃ is the acquiring time of the pressure of the collecting point P3.

Further, in some embodiments, after the step S2113 and before the step S2114, the following steps may also be included:

The discrete curvature is calibrated according to a formula

$$δ {K}_{i} = \frac{{K}_{i - 1} + {K}_{i} + {K}_{i + 1}}{3}$$

in which δKᵢ is the calibrated discrete curvature of the i-th collecting point.

Specifically, after calculating the discrete curvatures of the three adjacent collecting points on the pressure profile, the discrete curvatures of the three adjacent collecting points may be averaged, and the average value may be defined as the discrete curvature of the intermediate collecting points. For example, in some specific embodiments, after calculating the discrete curvatures of the collecting points P3, P4, and P5, the average value of the discrete curvature of the collecting points P3, P4, and P5 may be defined as the discrete curvature of the collecting point P4.

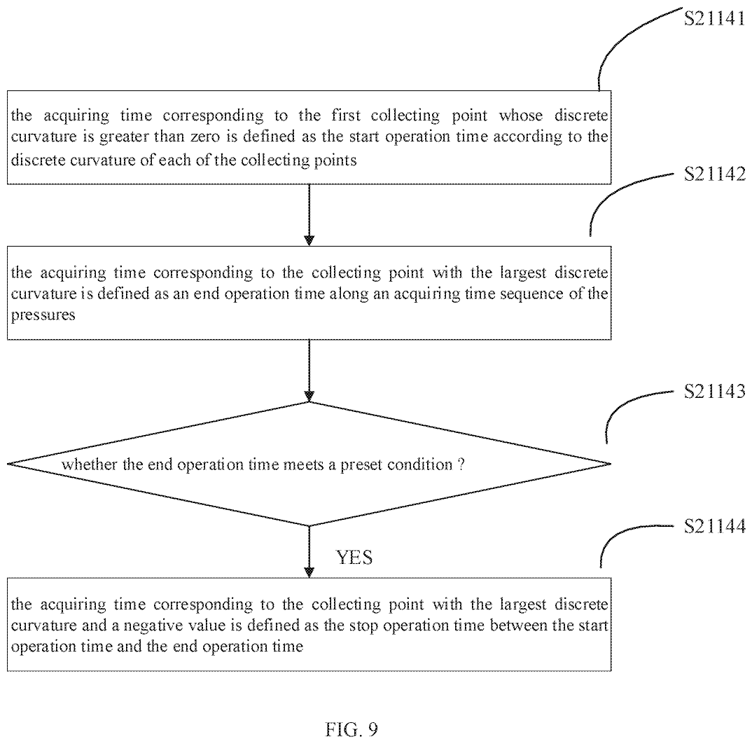

In some embodiments, as shown in FIG. 9, the step S2114 of the method for inspecting the operation period of the valve box 10 of the present disclosure, may specifically include:

At step S21141: the acquiring time corresponding to the first collecting point whose discrete curvature is greater than zero is defined as the start operation time according to the discrete curvature of each of the collecting points.

Specifically, when the valve box 10 is not in operation, the pressure of the liquid outlet 112 is generally maintained smoothly. At this time, the discrete curvature of each of the collecting points is 0. When the valve box 10 starts to operate, the pressure of the liquid outlet 112 increases dramatically in a short time, and at this time, the discrete curvature of the collecting point corresponding to the start operation time of the valve box 10 is greater than 0. For example, in the embodiment shown in FIG. 8, the discrete curvature of the collecting point P1 is equal to 0, the discrete curvature of the collecting point P2 is greater than 0, and the valve box 10 starts to operate at the time corresponding to the collecting point P2. At this time, the acquiring time corresponding to the collecting point P2 is defined as the start operation time.

At step S21142: the acquiring time corresponding to the collecting point with the largest discrete curvature is defined as an end operation time along an acquiring time sequence of the pressures.

In particular, it is appreciated from the above description that the operation of the valve box 10 includes pressurization and depressurization processes. After the depressurization of the valve box 10 is completed, the pressure of the liquid outlet 112 of the valve box 10 is again maintained stable. The time at which the valve box 10 completes the depressurization is defined as the end operation time. When the depressurization of the valve box 10 is completed, the pressure of the liquid outlet 112 of the valve box 10 is dramatically reduced in a short time. At this time, the discrete curvature of the collecting point corresponding to the end operation time of the valve box 10 is the largest. For example, in the embodiment shown in FIG. 8, the discrete curvature of the collecting point P6 is the largest, and the valve box 10 ends operation at the time corresponding to the collecting point P6. At this time, the acquiring time corresponding to the collecting point P6 is defined as the end operation time.

At step S21143: it is determined whether the end operation time meets a preset condition.

If the end operation time meets the preset condition, step S21144 is carried out. At step S21144: the acquiring time corresponding to the collecting point with the largest discrete curvature and a negative value is defined as the stop operation time between the start operation time and the end operation time.

Specifically, the valve box 10 is pressurized by the movement of a plunger pump, while the depressurization of the valve box 10 is typically a natural depressurization. In other words, when the pressurization of the valve box 10 is completed, the valve box 10 is stopped. At this time, the valve box 10 starts to naturally release the pressure. When the depressurization of the valve box 10 is completed, the operation of the valve box 10 is ended, that is, the valve box 10 is stopped. The time at which the valve box 10 completes the pressurization and starts the natural depressurization is defined as the stop operation time. The stop operation time is located between the start operation time and the end operation time, and the discrete curvature of the collecting point corresponding to the stop operation time is the largest and the value is negative. For example, in the embodiment shown in FIG. 8, the collecting point P5 is located between the start operation time corresponding to the collecting point P2 and the end operation time corresponding to the collecting point P6, and the discrete curvature of the collecting point P5 is largest and the value is negative. The valve box 10 is stopped at the time corresponding to collecting point P5. At this time, the acquiring time corresponding to the collecting point P5 is defined as the stop operation time.

It is to be distinguished that, in the above-described embodiment, the stop operation time refers to the time when the pressurization of valve box 10 is completed and the natural depressurization of valve box 10 is started. The end operation time refers to the time when the valve box 10 completes the natural depressurization. Although the liquid outlet 112 of the valve box 10 has a pressure change between the stop operation time and the end operation time, the valve box 10 is not in substantial operation state. Therefore, in the method for inspecting the operation period of the valve box 10 of the present disclosure, the single operation period of the valve box 10 refers to the length of time from the start operation time to the stop operation time of the valve box 10.

In some embodiments, the preset conditions in step S21143 of the method for inspecting the operation period of the valve box 10 of the present disclosure described above include:

A time difference between the end operation time and the start operation time is greater than or equal to ten first preset periods and is less than or equal to three thousand first preset periods.

The time difference between the end operation time and the start operation time is greater than or equal to ten first preset periods, that is, there are ten or more collecting points between the collecting point of the end operation time and the collecting point of the start operation time. The time difference between the end operation time and the start operation time is less than or equal to three thousand first preset periods, that is, there are three thousand or less than three thousand collecting points between the collecting point of the end operation time and the collecting point of the start operation time. For example, when the first preset period is 30 seconds, the time difference between the end operation time and the start operation time should be greater than or equal to 300 seconds, and be less than or equal to 90,000 seconds.

It should be understood that the description of the embodiment and the embodiment shown in FIG. 8 should not be construed as conflicting. FIG. 8 is only a view showing a pressure variation profile during the operation of the valve box 10 within a limited range. The time difference between the end operation time and the start operation time of the valve box 10 shall be subject to the above-described text.

The operation period of the valve box 10 is inspected according to the stress of the housing 110.

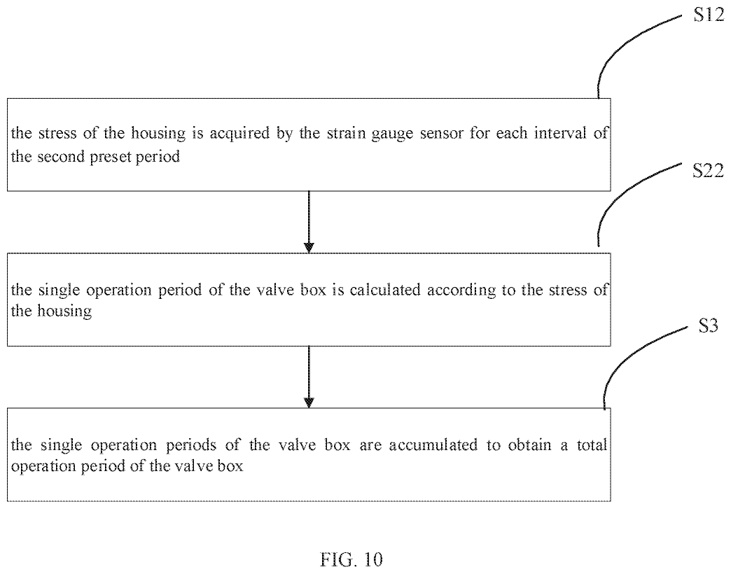

In some embodiments, as shown in FIG. 10, step S1 of the method for inspecting the operation period of the valve box 10 described above includes:

At step S12: the stress of the housing 110 is acquired by the strain gauge sensor 124 for each interval of the second preset period.

The second preset period here also refers to a preset length of time. For example, the second preset period may be 0.02 seconds, 0.05 seconds, or 0.1 seconds. The “second” herein is only used to distinguish from the aforementioned first preset period and does not have other definitions.

In some embodiments, the second preset period may be 0.05 seconds. At this time, at the step S12, the stress of the housing 110 is acquired once by the strain gauge sensor 124 every 0.05 seconds.

Based on the step S12 described above, step S2 may include:

At step S22: the single operation period of the valve box 10 is calculated according to the stress of the housing 110.

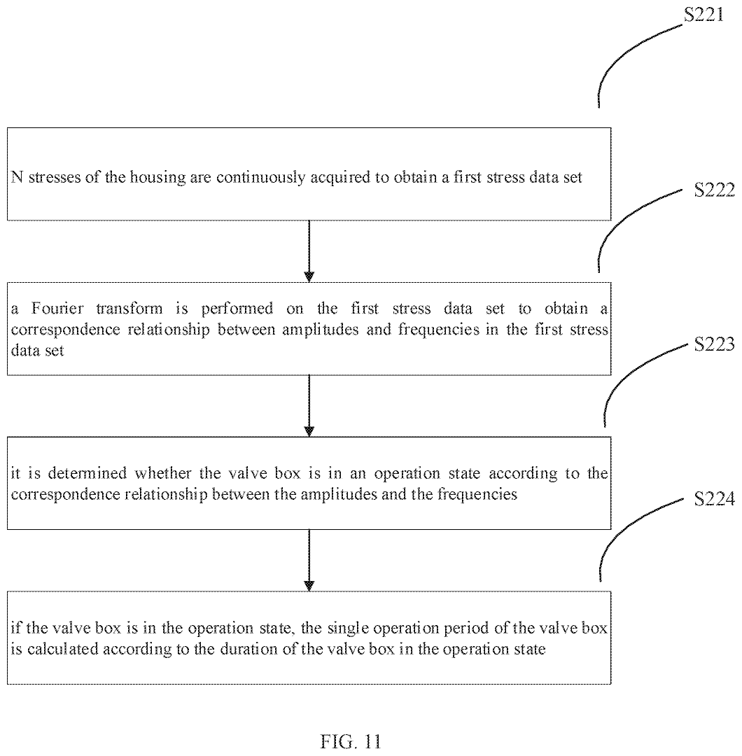

In some embodiments, as shown in FIG. 11, the step S22 may include:

At step S221: N stresses of the housing 110 are continuously acquired to obtain a first stress data set.

“N” in the N stresses of the housing 110 is a limit to the stresses of the housing 110. Here, “N” refers to an integer of three or more, and “N” is a preset value. Here, the N continuously acquired stresses of the housing 110 means acquiring the stress of the housing 110 once for each interval of the second preset period according to the second preset period, obtaining a plurality of stress data. At this time, each stress corresponds to one time, and the time difference between two adjacent stresses is the second preset period.

After continuously acquiring N stresses of the housing 110, the N stresses of the housing 110 are regarded as a set of data, i.e., the first stress data set T1. Each stress in the first stress data set T1 has a unique time, in other words, the first stress data set T1 is a stress data set in a time domain.

At step S222: a Fourier transform is performed on the first stress data set to obtain a correspondence relationship between amplitudes and frequencies in the first stress data set.

The Fourier transform is performed on the first stress data set T1 and the correspondence relationship between the amplitudes and the frequencies can be obtained. In other words, the time domain can be converted into a frequency domain by the Fourier transform.

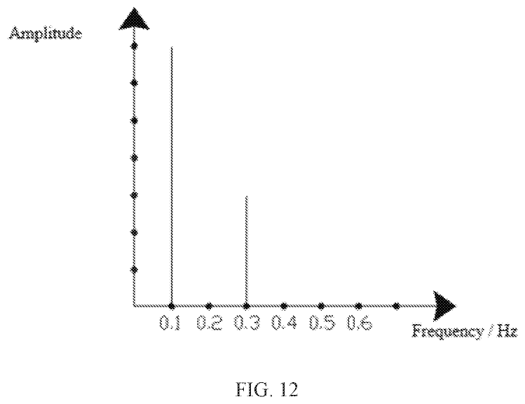

In some embodiments, the first stress data set T1 is decimated in time by using a fast Fourier transform (FFT), then the Fourier transform can be performed on the first stress data set T1. In some specific embodiments, the correspondence relationship between the amplitudes and the frequencies obtained after the FFT is shown in FIG. 12.

At step S223: it is determined whether the valve box 10 is in an operation state according to the correspondence relationship between the amplitudes and the frequencies.

After the correspondence relationship between the amplitudes and the frequencies is obtained, it can be determined whether the valve box 10 is in the operation state within the time range corresponding to the first stress data set T1 according to the correspondence relationship between the amplitudes and the frequencies.

At step S224: if the valve box 10 is in the operation state, the single operation period of the valve box 10 is calculated according to the duration of the valve box 10 in the operation state.

In some specific embodiments, as described above, the housing 110 has a connecting hole 114 for inserting the plunger. When the valve box 10 is in operation, the correspondence relationship between the amplitudes and the frequencies is shown in FIG. 12. It is apparent that the FIG. 12 contains a first frequency with a frequency of 0.1 Hz and a second frequency with a frequency of 0.3 Hz. The amplitudes corresponding to the first frequency and the second frequency are different. The first frequency is an operation frequency of the valve box 10, and the first amplitude is an operation amplitude of the valve box 10. The second frequency is an operation frequency of the plunger and the second amplitude is an operation amplitude of the plunger. In other words, when the valve box 10 is in normal operation, the correspondence relationship between the amplitudes and the frequencies includes not only the first frequency of the valve box 10 in the operation state but also the second frequency of the plunger in the operation state.

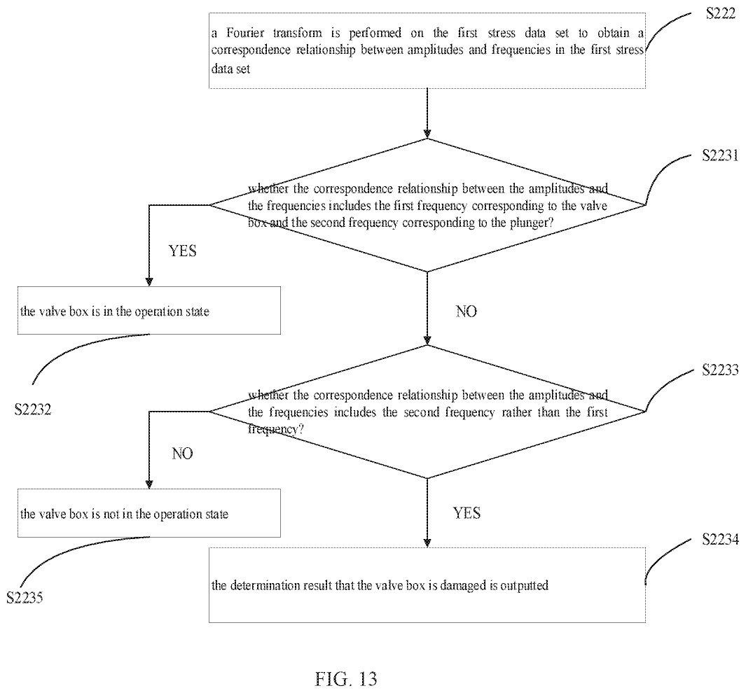

At this time, as shown in FIG. 13, the step S223 described above may include:

At step S2231: it is determined whether the correspondence relationship between the amplitudes and the frequencies includes the first frequency corresponding to the valve box 10 and the second frequency corresponding to the plunger.

As is known from the above description, when the valve box 10 is in normal operation, the correspondence relationship between the amplitudes and the frequencies includes not only the first frequency of the valve box 10 in the operation state but also the second frequency of the plunger in the operation state. Thus, it is determined whether the valve box 10 is in the operation state according to whether the correspondence relationship between the amplitudes and the frequencies including the first frequency and the second frequency at the same time.

If the correspondence relationship between the amplitudes and the frequencies includes the first frequency corresponding to the valve box 10 and the second frequency corresponding to the plunger at the same time, then step S2232 is performed, that is, the valve box 10 is in the operation state.

Further, if the correspondence relationship between the amplitudes and the frequencies does not include the first frequency corresponding to the valve box 10 and the second frequency corresponding to the plunger at the same time, then step S2233 is performed, that is, it is determined whether the correspondence relationship between the amplitudes and the frequencies includes the second frequency rather than the first frequency.

If the correspondence relationship between the amplitudes and the frequencies includes the second frequency rather than the first frequency, then step S2234 is performed, that is, a determination result that the valve box 10 is damaged is outputted.

When the correspondence relationship between the amplitudes and the frequencies includes the second frequency rather than the first frequency, the correspondence relationship between the amplitudes and the frequencies includes only the frequency of the plunger in the operation state rather than the frequency of the valve box 10 in the operation state. At this time, as the plunger reciprocates, the stable stress of the valve box 10 indicates that the valve box 10 is cracked or in other damaged condition. Therefore, the method for inspecting the operation period of the valve box 10 of the present disclosure can output the determination result that the valve box 10 is damaged.

The method for inspecting the operation period of the valve box 10 of the present disclosure can simultaneously output the accumulated operation period of the valve box 10 which is an operation life of the valve box 10, when outputting the determination result that the valve box 10 is damaged.

When correspondence relationship between the amplitudes and the frequencies does not include the second frequency rather than the first frequency, then step S2235 is performed, that is, the valve box 10 is not in the operation state.

When the determination result of the step S2233 is NO, there are two cases: First, neither the first frequency nor the second frequency is included in the correspondence relationship between the amplitudes and the frequencies. At this time, the correspondence relationship between the amplitudes and the frequencies includes neither the operation frequency of the plunger nor the operation frequency of the valve box 10, and it may be considered that the valve box 10 is still and is not in the operation state. Second, only the first frequency is included in the correspondence relationship between the amplitudes and the frequencies. At this time, only the first frequency of the valve box 10 in a vibration state is included in the correspondence relationship between the amplitudes and the frequencies. At this time, it is possible that the valve box 10 is in a moving state but not in the operation state.

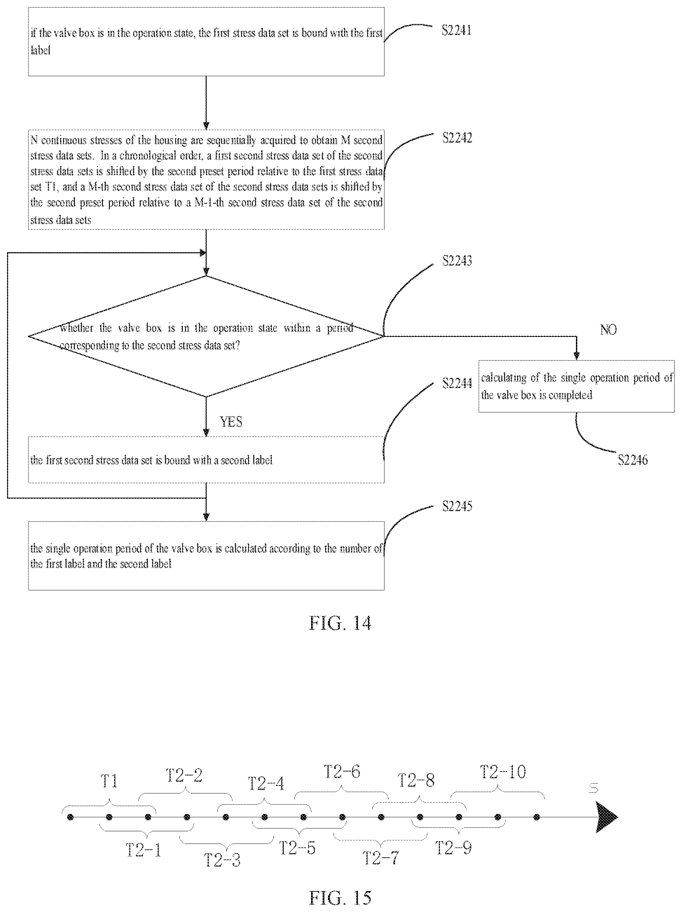

In some embodiments, as shown in FIG. 14, the step S224 of the method for inspecting the operation period of the valve box 10 of the present disclosure may include:

At step S2241: if the valve box 10 is in the operation state, the first stress data set is bound with the first label.

The steps before the step S2241 are the steps S221 to S223. In the foregoing embodiments, the steps S221 to S223 need to acquire the first stress data set T1. The Fourier transform is performed on the first stress data set T1 to obtain the correspondence relationship between the amplitudes and the frequencies. It is determined whether the valve box 10 is in the operation state according to the correspondence relationship between the amplitudes and the frequencies.

Therefore, when step S2241 determines that the valve box 10 is in the operation state, the valve box 10 starts to operate.

In some specific embodiments, prior to the first operation of the valve box 10, the method for inspecting the operation period of the valve box 10 of the present disclosure is started.

At step S2242: N continuous stresses of the housing 110 are sequentially acquired to obtain M second stress data sets. In a chronological order, a first second stress data set of the second stress data sets is shifted by the second preset period relative to the first stress data set T1, and a M-th second stress data set of the second stress data sets is shifted by the second preset period relative to a M−1-th second stress data set of the second stress data sets.

Specifically, as shown in FIG. 15, after the first stress data set T1 is obtained, if the valve box 10 is in the operation state, M second stress data sets are sequentially acquired. Here M is an integer of one or more. N stresses of the housing 110 are also included in each second stress data set, and a first second stress data set of the second stress data sets T2-1 is shifted by the second preset period relative to the first stress data set T1. A second stress data set T2-2 is shifted by the second preset period relative to a first second stress data set of the second stress data sets T2-1. The M-th second stress data set T2-M is shifted by the second preset period relative to the M−1-th second stress data set T2-(M−1).

At step S2243: It is sequentially determined whether the valve box 10 is in the operation state within a period corresponding to the second stress data set. If the valve box 10 is in the operation state, step S2244 is performed, that is, the first second stress data set is bound with a second label.

After the valve box 10 is in the operation state within a period corresponding to the first stress data set T1, and it is determined whether the valve box 10 is in the operation state starting from the first second stress data set T2-1. If the valve box 10 is in the operation state within a period corresponding to the first second stress data set T2-1, the first second stress data set T2-1 is bound with the second label.

If the valve box 10 is in the operation state within the period corresponding to the first second stress data set T2-1, it is determined whether the valve box 10 is in the operation state within a period corresponding to the second stress data set T2-2. If the valve box 10 is in the operation state within the period corresponding to the second stress data set T2-2, the second stress data set T2-2 is bound with the second label.

The determination will continue until the valve box 10 is not in the operation state within a period corresponding to the X-th (X means an unknown number) second stress data set.

In the process, the method determining whether the valve box 10 is in the operation state within the period corresponding to the second stress data set is the same with the method determining whether the valve box 10 is in the operation state within the period corresponding to the first stress data set T1. That is, the method determining whether the valve box 10 is in the operation state within the period corresponding to the second stress data set is that: the Fourier transform is performed on the second stress data to obtain the correspondence relationship between the amplitudes and the frequencies of the second stress data set. It is determined whether the valve box 10 is in the operation state according to the correspondence relationship between the amplitudes and the frequencies.

At step S2245: the single operation period of the valve box 10 is calculated according to the number of the first label and the second label.

In some specific embodiments, the step S2244 may include:

The single operation period of the valve box 10 is calculated according to a formula Lᵥ=t₂×N+t₂×K.

In the above formula, Lᵥ is the single operation period of the valve box 10; t₂ is the second preset period; K is the number of the second label.

In some embodiments, after the step S2243, the method for inspecting the operation period of the valve box 10 of the present disclosure further includes:

If the valve box 10 is not in the operation state within the period corresponding to the second stress data set, step S2246 is performed, that is, the calculating of the single operation period of the valve box 10 is completed.

If the valve box 10 is not in the operation state within the period corresponding to a second stress data set starting from the valve box 10 being in the operation state within the period corresponding to the first stress data set, the calculating of the single operation period of the valve box 10 is completed.

The total operation period of the valve box 10 can be obtained by accumulating the single operation periods of the valve box 10.

The operation period of the valve box 10 is inspected according to the acceleration of the housing 110. In the method for inspecting the operation period of the valve box 10 of the present disclosure, the inspecting of the operation period of the valve box 10 according to the acceleration of the housing 110 is same in principle with the inspecting of the operation period of the valve box 10 according to the acceleration of the valve box 10 described above. A procedure of the inspecting the operation period of the valve box 10 according to the acceleration of the housing 110 will be briefly described below:

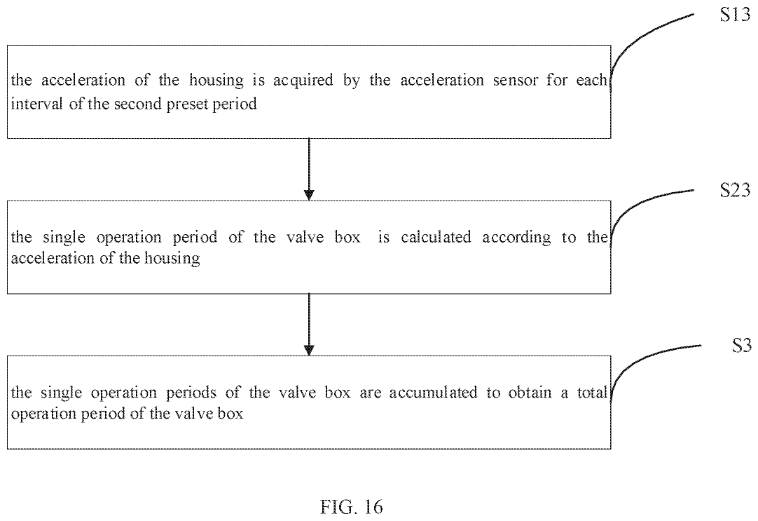

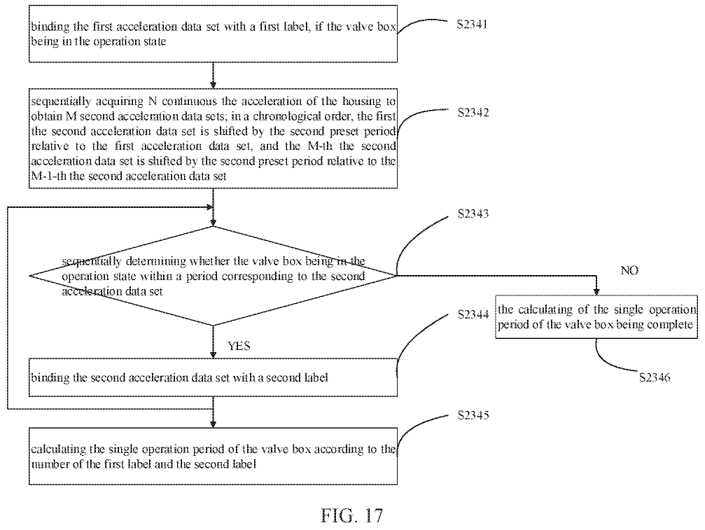

In some embodiments, as shown in FIG. 16, the step S1 of the method for inspecting the operation period of the valve box 10 described above includes:

At step S13: the acceleration of the housing 110 is acquired by the acceleration sensor 126 for each interval of the second preset period.

The second preset period here also refers to a preset length of time. For example, the second preset period may be 0.02 seconds, 0.05 seconds, or 0.1 seconds. The “second” herein is only used to distinguish from the above-described first preset period and does not have other meaning.

In some embodiments, the second preset period may be 0.05 seconds. At this time, at step S13, the acceleration of the housing 110 is acquired once by the acceleration sensor 126 every 0.05 seconds.

Based on the step S13 described above, the step S2 may include:

At step S23: the single operation period of the valve box 10 is calculated according to the acceleration of the housing 110.

In some embodiments, the step S23 may include:

At step S231: N continuous accelerations of the housing 110 are acquired to obtain the first acceleration data set.

“N” in the N accelerations of the housing 110 is a limit to the acceleration of the housing 110. Here, “N” refer to an integer of three or more, and “N” is a preset value. Here, acquiring N continuous accelerations of the housing 110 means acquiring the acceleration of the housing 110 once for each interval of the second preset period according to the second preset period, obtaining a plurality of acceleration data. At this time, each acceleration corresponds to one time, and the time difference between two adjacent acceleration is the second preset period.

After acquiring N continuous accelerations of the housing 110, the N accelerations of the housing 110 are regarded as a set of data, i.e., the first acceleration data set. Each acceleration in the first acceleration data set has a unique time, in other words, the first acceleration data set is an acceleration data set in the time domain.

At step S232: the Fourier transform is performed on the first acceleration data set to obtain a correspondence relationship between amplitudes and frequencies in the first acceleration data sets.

The Fourier transform is performed on the first acceleration data set and the correspondence relationship between the amplitudes and the frequencies can be obtained. In other words, the time domain can be converted into the frequency domain by the Fourier transform.

In some embodiments, the first acceleration data set is decimated in time by using the FFT, then the Fourier transform can be performed on the first acceleration data set.

At step S233: it is determined whether the valve box 10 is in the operation state according to the correspondence relationship between the amplitudes and the frequencies.

After the correspondence relationship between the amplitudes and the frequencies is obtained, it can be determined whether the valve box 10 is in the operation state within the time range corresponding to the first acceleration data set according to the correspondence relationship between the amplitudes and the frequencies.

At step S234: if the valve box 10 is in the operation state, the single operation period of the valve box 10 is calculated according to the duration of the valve box 10 in the operation state.

In some specific embodiments, the correspondence relationship between the amplitudes and the frequencies during the normal operation of the valve box 10 includes not only the first frequency of the valve box 10 in the operation state, but also the second frequency of the plunger in the operation state.

At this time, the step S233 described above may include:

At step S2231: it is determined whether the correspondence relationship between the amplitudes and the frequencies includes the first frequency corresponding to the valve box 10 and the second frequency corresponding to the plunger.

As is known from the above description, when the valve box 10 is in normal operation, the correspondence relationship between the amplitudes and the frequencies includes not only the first frequency of the valve box 10 in the operation state but also the second frequency of the plunger in the operation state. Thus, it is determined whether the valve box 10 is in the operation state according to whether the correspondence relationship between the amplitudes and the frequencies including the first frequency and the second frequency at the same time.

If the correspondence relationship between the amplitudes and the frequencies includes the first frequency corresponding to the valve box 10 and the second frequency corresponding to the plunger at the same time, then step S2232 is performed, that is, the valve box 10 is in the operation state.

Further, if the correspondence relationship between the amplitudes and the frequencies does not include the first frequency corresponding to the valve box 10 and the second frequency corresponding to the plunger at the same time, then step S2233 is performed, that is, it is determined whether the correspondence relationship between the amplitudes and the frequencies includes the second frequency rather than the first frequency.

If the correspondence relationship between the amplitudes and the frequencies includes the second frequency rather than the first frequency, then step S2234 is performed, that is, the determination result that the valve box 10 is damaged is outputted.

When the correspondence relationship between the amplitudes and the frequencies includes the second frequency rather than the first frequency, at this time, the correspondence relationship between the amplitudes and the frequencies includes only the frequency of the plunger in the operation state rather than the frequency of the valve box 10 in the operation state. At this time, as the plunger reciprocates, the acceleration of the valve box 10 is unchanged and indicates that the valve box 10 is cracked or in other damaged condition. Therefore, the method for inspecting the operation period of the valve box 10 of the present disclosure can output the determination result that the valve box 10 is damaged.

The method for inspecting the operation period of the valve box 10 of the present disclosure can simultaneously output the accumulated operation period of the valve box 10 which is an operation life of the valve box 10 when outputting the determination result that the valve box 10 is damaged.

When the correspondence relationship between the amplitudes and the frequencies does not include the second frequency rather than the first frequency, then the step S2235 is performed, that is, the valve box 10 is not in the operation state.

When the determination result of the step S2233 is NO, there are two cases: First, neither the first frequency nor the second frequency is included in the correspondence relationship between the amplitudes and the frequencies. At this time, the correspondence relationship between the amplitudes and the frequencies includes neither the operation frequency of the plunger nor the operation frequency of the valve box 10, and it may be considered that the valve box 10 is still and is not in the operation state. Second, only the first frequency is included in the correspondence relationship between the amplitudes and the frequencies. At this time, only the first frequency of the valve box 10 in the vibration state is included in the correspondence relationship between the amplitudes and the frequencies. At this time, it is possible that the valve box 10 is in a moving state but not in the operation state.

In some embodiments, as shown in FIG. 17, the step S234 of the method for inspecting the operation period of the valve box 10 of the present disclosure may include:

At step S2341: if the valve box 10 is in the operation state, the first acceleration data set is bound with the first label.

The steps before the step S2341 are steps S231 to S233. In the foregoing embodiments, steps S231 to S233 need to acquire the first acceleration data set. The Fourier transform is performed on the first acceleration data set to obtain the correspondence relationship between the amplitudes and the frequencies. It is determined whether the valve box 10 is in the operation state according to the correspondence relationship between the amplitudes and the frequencies.

Therefore, when the step S2341 determines that the valve box 10 is in the operation state, the valve box 10 starts to operate.

In some specific embodiments, prior to the operation of the valve box 10, the method for inspecting the operation period of the valve box 10 of the present disclosure is started.

At step S2342: N continuous accelerations of the housing 110 is sequentially acquired to obtain M second acceleration data sets. In a chronological order, a first second acceleration data set is shifted by the second preset period relative to a first acceleration data set, and a M-th second acceleration data set is shifted by the second preset period relative to a M−1-th second acceleration data set.

Specifically, after the first acceleration data set is obtained, if the valve box 10 is in the operation state, M second acceleration data sets are sequentially acquired. Here, M is an integer of one or more. N accelerations of the housing 110 are also included in each second acceleration data set, and a first second acceleration data set is shifted by the second preset period relative to a first acceleration data set. A second acceleration data set is shifted by the second preset period relative to a first second acceleration data set. A M-th second acceleration data set is shifted by the second preset period relative to a M−1-th second acceleration data set.

At step S2343: It is sequentially determined whether the valve box 10 is in the operation state within a period corresponding to the second acceleration data set. If the valve box 10 is in the operation state, step S2344 is performed, that is, the first second acceleration data set is bound with a second label.

After the valve box 10 is in the operation state within a period corresponding to the first acceleration data set, it is determined whether the valve box 10 is in the operation state starting from the first second acceleration data set. If the valve box 10 is in the operation state within a period corresponding to the first second acceleration data set, the first second acceleration data set is bound with the second label.

If the valve box 10 is in the operation state within the period corresponding to the first second stress data set, it is determined whether the valve box 10 is in the operation state within a period corresponding to the second stress data set. If the valve box 10 is in the operation state within the period corresponding to the second stress data set, the second stress data set is bound with the second label.

The determination will continue until the valve box 10 is not in the operation state within a period corresponding to a second acceleration data set.

In the process, the method determining whether the valve box 10 is in the operation state within the period corresponding to the second acceleration data set is the same with the method determining whether the valve box 10 is in the operation state within the period corresponding to the first acceleration data set. That is, the method determining whether the valve box 10 is in the operation state within the period corresponding to the second acceleration data set is: the Fourier transform is performed on the second acceleration data to obtain the correspondence relationship between the amplitudes and the frequencies. It is determined whether the valve box 10 is in the operation state according to the correspondence relationship between the amplitudes and the frequencies.

At step S2345: the single operation period of the valve box 10 is calculated according to the number of the first label and the second label.

In some specific embodiments, step S2344 may include:

The single operation period of the valve box 10 is calculated according to a formula Lᵥ=t₂×N+t₂×K;

In the above formula, Lᵥ is the single operation period of the valve box 10; t₂ is the second preset period; K is the number of second labels.

In some embodiments, after the step S2343, the method for inspecting the operation period of the valve box 10 of the present disclosure further includes:

If the valve box 10 is not in the operation state within the period corresponding to the second acceleration data set, step S2346 is performed, that is, the calculating of the single operation period of the valve box 10 is completed.

If the valve box 10 is not in the operation state within the period corresponding to a second acceleration data set starting from the valve box 10 being in the operation state within the period corresponding to the first acceleration data set, the calculating of the single operation period of the valve box 10 is completed.

The total operation period of the valve box 10 can be obtained by accumulating the single operation periods of the valve box 10.

It should be noted that, in the above-described embodiment of the present disclosure, three different parallel embodiments are provided for inspecting the operation period of the valve box 10. That is, the operation period of the valve box 10 is inspected according to the pressure of the liquid outlet 112. The operation period of the valve box 10 is inspected according to the stress of the housing 110. The operation period of the valve box 10 is inspected according to the acceleration of the housing 110.

When two or three parallel embodiments are selected for inspecting the operation period of the valve box 10, regard the average value of the operation period of the valve box 10 inspected by different inspecting methods as the final total operation period of the valve box 10. In one embodiment, also select the operation period of the valve box 10 obtained by different inspecting methods to obtain the final total operation period of the valve box 10.

In some embodiments, the present disclosure also provides a system for inspecting an operation period of a valve box 10. The system includes the valve box 10, and a computer apparatus, and at least one of a pressure sensor, a strain gauge sensor 124, and an acceleration sensor 126.

The valve box 10 includes a housing 110 provided with a liquid outlet 112 for discharging liquid.

The pressure sensor is provided at the liquid outlet 112, and the strain gauge sensor 124 and the acceleration sensor 126 are embedded in the housing 110.

A computer apparatus is connected to the pressure sensor, the strain gauge sensor 124, and the acceleration sensor 126.

In some embodiments, when the computer apparatus is in operation, the following steps can be implemented: at least one of a pressure of the liquid outlet 112, a stress of the housing 110, and an acceleration of the housing 110 is acquired. Single operation periods of the valve box 10 are calculated according to at least one of a pressure of the liquid outlet 112, a stress of the housing 110, and an acceleration of the housing 110. The single operation periods of the valve box 10 are accumulated to obtain a total operation period of the valve box 10.

In some embodiments, the acquiring at least one of the pressure of the liquid outlet 112, the stress of the housing 110, and the acceleration of the housing 110 includes: the pressure of the liquid outlet 112 is acquired through the pressure sensor for each interval of a first preset period. The calculating the single operation period of the valve box 10 according to at least one of the pressure of the liquid outlet 112, the stress of the housing 110, and the acceleration of the housing 110 includes: a start operation time and a stop operation time of the valve box 10 are acquired according to the pressure of the liquid outlet 112. The single operation period of the valve box 10 is calculated according to the start operation time and the stop operation time of the valve box 10.

In some embodiments, the acquiring the start operation time and the stop operation time of the valve box 10 according to the pressure of the liquid outlet 112 includes: a plurality of pressures of the outlet 112 are continuously acquired to obtain a plurality of collecting points according to the plurality of continuous pressures of the liquid outlet 112 and the first preset period. Each of the collecting points includes an acquiring time of the pressure of the liquid outlet 112 and the pressure of the liquid outlet 112. A pressure profile corresponding to the collecting points is acquired according to the plurality of collecting points. A discrete curvature of each of the collecting points on the pressure profile is acquired. The start operation time and the stop operation time of the valve box 10 are acquired according to the discrete curvature of each of the collecting points.

In some embodiments, the acquiring the discrete curvature of each of the collecting points on the pressure profile includes calculating the discrete curvature of each of the collecting points on the pressure profile according to a formula

$${K}_{i} = \frac{Δ {θ}_{i}}{Δ {L}_{i}} .$$

In the above formula, Kᵢ is the discrete curvature of the i-th collecting point.

$$Δ {θ}_{i} = arctan ( \frac{( {f}_{i} - {f}_{i + 2} ) ( {s}_{i} - {s}_{i - 2} ) - ( {f}_{i} - {f}_{i - 2} ) ( {s}_{i} - {s}_{i + 2} )}{1 + ( {s}_{i} - {s}_{i - 2} ) ( {s}_{i} - {s}_{i + 2} )} ) \\ Δ {L}_{i} = \sqrt{{( {s}_{i + 1} - {s}_{i} )}^{2} + {( {f}_{i + 1} - {f}_{i} )}^{2}} + \sqrt{{( {s}_{i} - {s}_{i - 1} )}^{2} + {( {f}_{i} - {f}_{i - 1} )}^{2}}$$

fᵢ is the pressure of the liquid outlet 112 of the i-th collecting point; and sᵢ is the acquiring time of the pressure of the liquid outlet 112 of the i-th collecting point 112.

In some embodiments, before the acquiring the start operation time and the stop operation time of the valve box 10 according to the discrete curvature of each of the collecting points, the method further includes: calibrating the discrete curvature according to a formula

$$δ {K}_{i} = \frac{{K}_{i - 1} + {K}_{i} + {K}_{i + 1}}{3}$$

in which δKᵢ is the calibrated discrete curvature of the i-th collecting point.

In some embodiments, the acquiring the start operation time and the stop operation time of the valve box 10 according to the discrete curvature of each of the collecting points includes: the acquiring time corresponding to the first collecting point 112 whose discrete curvature is greater than zero is defined as the start operation time according to the discrete curvature of each of the collecting points. The acquiring time corresponding to the collecting point 112 with the largest discrete curvature is defined as an end operation time along the acquiring time sequence of the pressures. It is determined whether the end operation time meets a preset condition. If the end operation time meets the preset condition, the acquiring time corresponding to the collecting point 112 with the largest discrete curvature and a negative value is defined as the stop operation time between the start operation time and the end operation time.

In some embodiments, the preset condition includes: a time difference between the end operation time and the start operation time is greater than or equal to ten first preset periods and is less than or equal to three thousand first preset periods.

In some embodiments, the acquiring at least one of the pressure of the liquid outlet 112, the stress of the housing 110, and the acceleration of the housing 110 includes: the stress of the housing 110 is acquired by the strain gauge sensor 124 for each interval of a second preset period; or/and, the acceleration of the housing 110 is acquired by the acceleration sensor 126 for each interval of the second preset period. The acquiring the start operation time and the stop operation time of the valve box 10 according to at least one of the pressure of the liquid outlet 112, the stress of the housing 110, and the acceleration of the housing 110 includes: the single operation period of the valve box 10 is calculated according to the stress of the housing 110; or/and the single operation period of the valve box 10 is calculated according to the acceleration of the housing 110.

In some embodiments, the calculating of the single operation period of the valve box 10 according to the stress of the housing 110 includes: N continuous stresses of the housing 110 are acquired to obtain a first stress data set. A Fourier transform is performed on the first stress data set to obtain a correspondence relationship between amplitudes and frequencies in the first stress data set. It is determined whether the valve box 10 is in an operation state according to the correspondence relationship between the amplitudes and the frequencies. The single operation period of the valve box 10 is calculated according to a duration of the valve box 10 in the operation state if the valve box 10 is in the operation state.

In some embodiments, the housing 110 has a connecting hole 114 for inserting a plunger. The determining whether the valve box 10 being in the operation state according to the correspondence relationship between the amplitudes and the frequencies includes: it is determined whether the correspondence relationship between the amplitudes and the frequencies includes a first frequency corresponding to the valve box 10 and a second frequency corresponding to the plunger. If the correspondence relationship between the amplitudes and the frequencies includes the first frequency and the second frequency, the valve box 10 is in the operation state.

In some embodiments, after the determining whether the correspondence relationship between the amplitudes and the frequencies including the first frequency corresponding to the valve box 10 and the second frequency corresponding to the plunger, the method further includes: if the correspondence relationship between the amplitudes and the frequencies includes the second frequency rather than the first frequency, a determination result that the valve box 10 is damaged is outputted.

In some embodiments, the calculating the single operation period of the valve box 10 according to the duration of the valve box 10 in the operation state if the valve box 10 being in the operation state includes: the first stress data set is bound with a first label if the valve box 10 is in the operation state. N continuous stresses of the housing 110 are sequentially acquired to obtain M second stress data sets. In a chronological order, a first second stress data set of the second stress data sets is shifted by the second preset period relative to the first stress data set, and a M-th second stress data set of the second stress data sets is shifted by the second preset period relative to a M−1-th second stress data set of the second stress data sets. It is sequentially determined whether the valve box 10 is in the operation state within a period corresponding to the second stress data set. The second stress data set is bound with a second label if the valve box 10 is in the operation state. The single operation period of the valve box 10 is calculated according to the number of the first label and the second label.

In some embodiments, the calculating of the single operation period of the valve box 10 according to the number of the first label and the second label includes: the single operation period of the valve box 10 is calculated according to a formula Lᵥ=t₂×N+t₂×K. In the above formula, Lᵥ is the single operation period of the valve box 10; t₂ is the second preset period; K is the number of the second label.

In some embodiments, after the sequentially determining whether the valve box 10 being in the operation state within the period corresponding to the second stress data set, the method further includes: if the valve box 10 is not in the operation state, the calculating of the single operation period of the valve box 10 is completed.

In some embodiments, the calculating the single operation period of the valve box 10 according to the acceleration of the housing 110 includes: N continuous accelerations of the housing 110 are acquired to obtain a first acceleration data set. The Fourier transform is performed on N first acceleration data sets to obtain a correspondence relationship between amplitudes and frequencies in the first acceleration data sets. It is determined whether the valve box 10 is in the operation state according to the correspondence relationship between the amplitudes and the frequencies. The single operation period of the valve box 10 is calculated according to the duration of the valve box 10 in the operation state if the valve box 10 is in the operation state.

In some embodiments, a computer apparatus is provided, which may be a terminal. The computer apparatus includes a processor, a memory, a communication interface, a display screen, and an input device connected through a system bus. The processor of the computer apparatus is used to provide computing capability and control capability. The memory of the computer apparatus includes a non-volatile storage medium and a Random Access Memory (RAM). The non-volatile storage medium stores an operation system and a computer program. The RAM provides an environment for the operation of the operation system and the computer program in the non-volatile storage medium. The communication interface of the computer apparatus is used for wired or wireless communication with an external terminal. The wireless mode may be realized by WI-FI, an operator network, Near Field Communication (NFC), or other technologies. The computer program is executed by the processor to implement a method for inspecting an operation period of the valve box. The display screen of the computer apparatus may be a liquid crystal display screen or an electronic ink display screen, and the input device of the computer apparatus may be a touch layer covered on the display screen or a key, a trackball or a touch pad provided on a housing 110 of the computer apparatus. The input device can also be an external keyboard, touch pad, or mouse, etc.

In some embodiments, a computer apparatus is provided. The computer apparatus includes a memory and a processor. The memory stores computer program. When executing the computer program, the processor implements the following steps:

At least one of a pressure of the liquid outlet 112, a stress of the housing 110, and an acceleration of the housing 110 is acquired.

Single operation periods of the valve box 10 are calculated according to at least one of the pressure of the liquid outlet 112, the stress of the housing 110, and the acceleration of the housing 110.

The single operation periods of the valve box 10 are accumulated to obtain a total operation period of the valve box 10.

The implementation principle and technical effect of the computer apparatus provided in this embodiment are similar to those of the above-described method embodiments and are omitted for brevity.

In some embodiments, when executing the computer program, the processor also implements the following steps: the pressure of the liquid outlet 112 is acquired through a pressure sensor for each interval of a first preset period.

In some embodiments, when executing the computer program, the processor also implements the following steps: a start operation time and a stop operation time of the valve box 10 are acquired according to the pressure of the liquid outlet 112.

The single operation period of the valve box 10 is calculated according to the start operation time and the stop operation time of the valve box 10.

In some embodiments, when executing the computer program, the processor also implements the following steps: a plurality of pressures of the outlet 112 are continuously acquired to obtain a plurality of collecting points according to the plurality of continuous pressures of the liquid outlet 112 and the first preset period. Each of the collecting points includes an acquiring time of the pressure of the liquid outlet 112 and the pressure of the liquid outlet 112.

A pressure profile corresponding to the collecting points is acquired according to the plurality of collecting points.

A discrete curvature of each of the collecting points on the pressure profile is acquired.

The start operation time and the stop operation time of the valve box 10 are acquired according to the discrete curvature of each of the collecting points.

In some embodiments, when executing the computer program, the processor also implements the following steps: the discrete curvature of each of the collecting points on the pressure profile is calculated according to a formula

$${K}_{i} = \frac{Δ {θ}_{i}}{Δ {L}_{i}} .$$

In the above formula, Kᵢ is the discrete curvature of the i-th collecting point.

$$Δ {θ}_{i} = arctan ( \frac{( {f}_{i} - {f}_{i + 2} ) ( {s}_{i} - {s}_{i - 2} ) - ( {f}_{i} - {f}_{i - 2} ) ( {s}_{i} - {s}_{i + 2} )}{1 + ( {s}_{i} - {s}_{i - 2} ) ( {s}_{i} - {s}_{i + 2} )} ) \\ Δ {L}_{i} = \sqrt{{( {s}_{i + 1} - {s}_{i} )}^{2} + {( {f}_{i + 1} - {f}_{i} )}^{2}} + \sqrt{{( {s}_{i} - {s}_{i - 1} )}^{2} + {( {f}_{i} - {f}_{i - 1} )}^{2}}$$

fᵢ is the pressure of the liquid outlet 112 of the i-th collecting point; sᵢ is the acquiring time of the pressure of the liquid outlet 112 of the i-th collecting point.

In some embodiments, when executing the computer program, the processor also implements the following steps: the discrete curvature is calibrated according to a formula

$$δ {K}_{i} = \frac{{K}_{i - 1} + {K}_{i} + {K}_{i + 1}}{3}$$

in which δKᵢ is the calibrated discrete curvature of the i-th collecting point.

In some embodiments, when executing the computer program, the processor also implements the following steps: the acquiring time corresponding to the first collecting point 112 whose discrete curvature is greater than zero is defined as the start operation time according to the discrete curvature of each of the collecting points.

The acquiring time corresponding to the collecting point 112 with the largest discrete curvature is defined as an end operation time along the acquiring time sequence of the pressures.

It is determined whether the end operation time meets a preset condition.

If the end operation time meets the preset condition, the acquiring time corresponding to the collecting point 112 with the largest discrete curvature and a negative value is defined as the stop operation time between the start operation time and the end operation time.

In some embodiments, when executing the computer program, the processor also implements the following steps: a time difference between the end operation time and the start operation time is greater than or equal to ten first preset periods and is less than or equal to three thousand first preset periods.

In some embodiments, when executing the computer program, the processor also implements the following steps: the stress of the housing 110 is acquired by a strain gauge sensor 124 for each interval of a second preset period; or/and

The acceleration of the housing 110 is acquired by an acceleration sensor 126 for each interval of the second preset period.

In some embodiments, when executing the computer program, the processor also implements the following steps: the single operation period of the valve box 10 is calculated according to the stress of the housing 110.

The single operation period of the valve box 10 is calculated according to the acceleration of the housing 110.

In some embodiments, when executing the computer program, the processor also implements the following steps: N continuous stresses of the housing 110 are acquired to obtain a first stress data set.

A Fourier transform is performed on the first stress data set to obtain a correspondence relationship between amplitudes and frequencies in the first stress data set.

It is determined whether the valve box 10 is in an operation state according to the correspondence relationship between the amplitudes and the frequencies.

The single operation period of the valve box 10 is calculated according to a duration of the valve box 10 in the operation state if the valve box 10 is in the operation state.

In some embodiments, when executing the computer program, the processor also implements the following steps: it is determined whether the correspondence relationship between the amplitudes and the frequencies includes a first frequency corresponding to the valve box 10 and a second frequency corresponding to the plunger.

If the correspondence relationship between the amplitudes and the frequencies includes the first frequency and the second frequency, the valve box 10 is in the operation state.

In some embodiments, when executing the computer program, the processor also implements the following steps: if the correspondence relationship between the amplitudes and the frequencies includes the second frequency rather than the first frequency, a determination result is outputted that the valve box 10 is damaged.

In some embodiments, when executing the computer program, the processor also implements the following steps: the first stress data set is bound with a first label if the valve box 10 is in the operation state.

N continuous stresses of the housing 110 are sequentially acquired to obtain M second stress data sets. In a chronological order, a first second stress data set of the second stress data sets is shifted by the second preset period relative to the first stress data set, and a M-th second stress data set of the second stress data sets is shifted by the second preset period relative to a M−1-th second stress data set of the second stress data sets.

It is sequentially determined whether the valve box 10 is in the operation state within a period corresponding to the second stress data set. The second stress data set is bound with a second label if the valve box 10 is in the operation state.

The single operation period of the valve box 10 is calculated according to the number of the first label and the second label.

In some embodiments, when executing the computer program, the processor also implements the following steps: the single operation period of the valve box 10 is calculated according to a formula Lᵥ=t₂×N+t₂×K.

In the above formula, Lᵥ is the single operation period of the valve box 10; t₂ is the second preset period; K is the number of the second label.

In some embodiments, when executing the computer program, the processor also implements the following steps: if the valve box 10 is not in the operation state, the calculating of the single operation period of the valve box 10 is completed.

In some embodiments, when executing the computer program, the processor also implements the following steps: N continuous accelerations of the housing 110 are acquired to obtain a first acceleration data set.

The Fourier transform is performed on N of the first acceleration data sets to obtain a correspondence relationship between amplitudes and frequencies in the first acceleration data sets.

It is determined whether the valve box 10 is in the operation state according to the correspondence relationship between the amplitudes and the frequencies.

The single operation period of the valve box 10 is calculated according to the duration of the valve box 10 in the operation state if the valve box 10 is in the operation state.

In some embodiments, a computer-readable storage medium is provided on which a computer program is stored, when executed by a processor, the computer program implements the following steps:

At least one of a pressure of the liquid outlet 112, a stress of the housing 110, and an acceleration of the housing 110 is acquired.

Single operation periods of the valve box 10 are calculated according to at least one of the pressure of the liquid outlet 112, the stress of the housing 110, and the acceleration of the housing 110.

The single operation periods of the valve box 10 are accumulated to obtain a total operation period of the valve box 10.

The computer-readable storage medium provided in the embodiment has the same implementation principle and technical effect as those of the above-described method embodiments and are omitted for brevity.

In some embodiments, when executed by a processor, the computer program also implements the following steps: the pressure of the liquid outlet 112 is acquired through a pressure sensor for each interval of a first preset period.

In some embodiments, when executed by a processor, the computer program also implements the following steps: a start operation time and a stop operation time of the valve box 10 is acquired according to the pressure of the liquid outlet 112.

The single operation period of the valve box 10 is calculated according to the start operation time and the stop operation time of the valve box 10.

In some embodiments, when executed by a processor, the computer program also implements the following steps: a plurality of pressures of the outlet 112 are continuously acquired to obtain a plurality of collecting points according to the plurality of continuous pressures of the liquid outlet 112 and the first preset period. Each of the collecting points includes an acquiring time of the pressure of the liquid outlet 112 and the pressure of the liquid outlet 112.

A pressure profile corresponding to the collecting points is acquired according to the plurality of collecting points.

A discrete curvature of each of the collecting points is acquired on the pressure profile.

The start operation time and the stop operation time of the valve box 10 are acquired according to the discrete curvature of each of the collecting points.

In some embodiments, when executed by a processor, the computer program also implements the following steps: the discrete curvature of each of the collecting points on the pressure profile is calculated according to a formula

$${K}_{i} = \frac{Δ {θ}_{i}}{Δ {L}_{i}} .$$

In the above formula, Kᵢ is the discrete curvature of the i-th collecting point.

$$Δ {θ}_{i} = arctan ( \frac{( {f}_{i} - {f}_{i + 2} ) ( {s}_{i} - {s}_{i - 2} ) - ( {f}_{i} - {f}_{i - 2} ) ( {s}_{i} - {s}_{i + 2} )}{1 + ( {s}_{i} - {s}_{i - 2} ) ( {s}_{i} - {s}_{i + 2} )} ) \\ Δ {L}_{i} = \sqrt{{( {s}_{i + 1} - {s}_{i} )}^{2} + {( {f}_{i + 1} - {f}_{i} )}^{2}} + \sqrt{{( {s}_{i} - {s}_{i - 1} )}^{2} + {( {f}_{i} - {f}_{i - 1} )}^{2}}$$

fᵢ is the pressure of the liquid outlet 112 of the i-th collecting point; sᵢ is the acquiring time of the pressure of the liquid outlet 112 of the i-th collecting point.

In some embodiments, when executed by a processor, the computer program also implements the following steps: the discrete curvature is calibrated according to a formula

$$δ {K}_{i} = \frac{{K}_{i - 1} + {K}_{i} + {K}_{i + 1}}{3}$$

in which δKᵢ is the calibrated discrete curvature of the i-th collecting point.

In some embodiments, when executed by a processor, the computer program also implements the following steps: the acquiring time corresponding to the first collecting point 112 whose discrete curvature is greater than zero is defined as the start operation time according to the discrete curvature of each of the collecting points.

The acquiring time corresponding to the collecting point 112 with the largest discrete curvature is defined as an end operation time along the acquiring time sequence of the pressures.

It is determined whether the end operation time meets a preset condition.

If the end operation time meets the preset condition, the acquiring time corresponding to the collecting point 112 with the largest discrete curvature and a negative value is defined as the stop operation time between the start operation time and the end operation time.

In some embodiments, when executed by a processor, the computer program also implements the following steps: a time difference between the end operation time and the start operation time is greater than or equal to ten first preset periods and is less than or equal to three thousand first preset periods.

In some embodiments, when executed by a processor, the computer program also implements the following steps: the stress of the housing 110 is acquired by a strain gauge sensor 124 for each interval of a second preset period.

The acceleration of the housing 110 is acquired by an acceleration sensor 126 for each interval of the second preset period.

In some embodiments, when executed by a processor, the computer program also implements the following steps: the single operation period of the valve box 10 is calculated according to the stress of the housing 110.

The single operation period of the valve box 10 is calculated according to the acceleration of the housing 110.

In some embodiments, when executed by a processor, the computer program also implements the following steps: N continuous stresses of the housing 110 are acquired to obtain a first stress data set.

A Fourier transform is performed on the first stress data set to obtain a correspondence relationship between amplitudes and frequencies in the first stress data set.

It is determined whether the valve box 10 is in an operation state according to the correspondence relationship between the amplitudes and the frequencies.

The single operation period of the valve box 10 is calculated according to a duration of the valve box 10 in the operation state if the valve box 10 is in the operation state.

In some embodiments, when executed by a processor, the computer program also implements the following steps: it is determined whether the correspondence relationship between the amplitudes and the frequencies includes a first frequency corresponding to the valve box 10 and a second frequency corresponding to the plunger.

if the correspondence relationship between the amplitudes and the frequencies includes the first frequency and the second frequency, the valve box 10 is in the operation state.

In some embodiments, when executed by a processor, the computer program also implements the following steps: if the correspondence relationship between the amplitudes and the frequencies includes the second frequency rather than the first frequency, a determination result that the valve box 10 is damaged is outputted.

In some embodiments, when executed by a processor, the computer program also implements the following steps: the first stress data set is bound with a first label if the valve box 10 is in the operation state.

N continuous stresses of the housing 110 are sequentially acquired to obtain M second stress data sets. In a chronological order, a first second stress data set of the second stress data sets is shifted by the second preset period relative to the first stress data set, and a M-th second stress data set of the second stress data sets is shifted by the second preset period relative to a M−1-th second stress data set of the second stress data sets.

It is sequentially determined whether the valve box 10 is in the operation state within a period corresponding to the second stress data set. The second stress data set is bound with a second label if the valve box 10 is in the operation state.

The single operation period of the valve box 10 is calculated according to the number of the first label and the second label.

In some embodiments, when executed by a processor, the computer program also implements the following steps: the single operation period of the valve box 10 is calculated according to a formula Lᵥ=t₂×N+t₂×K.

In the above formula, Lᵥ is the single operation period of the valve box 10; t₂ is the second preset period; K is the number of the second label.

In some embodiments, when executed by a processor, the computer program also implements the following steps: if the valve box 10 is not in the operation state, the calculating of the single operation period of the valve box 10 is completed.

In some embodiments, when executed by a processor, the computer program also implements the following steps: N continuous accelerations of the housing 110 are acquired to obtain a first acceleration data set.

The Fourier transform is performed on N of the first acceleration data sets to obtain a correspondence relationship between amplitudes and frequencies in the first acceleration data sets.

It is determined whether the valve box 10 is in the operation state according to the correspondence relationship between the amplitudes and the frequencies.

The single operation period of the valve box 10 is calculated according to the duration of the valve box 10 in the operation state if the valve box 10 is in the operation state.

The foregoing respective technical features involved in the respective embodiments can be combined arbitrarily, for brevity, not all possible combinations of the respective technical features in the foregoing embodiments are described, however, to the extent they have no collision with each other, the combination of the respective technical features shall be considered to be within the scope of the description.

What is claimed is:

1. A method for inspecting an operation period of a valve box, the valve box comprising a housing provided with a liquid outlet, the method comprising:
acquiring at least one of a pressure of the liquid outlet, a stress of the housing, and an acceleration of the housing;
calculating single operation periods of the valve box according to at least one of the pressure of the liquid outlet, the stress of the housing, and the acceleration of the housing; and
accumulating the single operation periods of the valve box to obtain a total operation period of the valve box.

2. The method according to claim 1, wherein the acquiring at least one of the pressure of the liquid outlet, the stress of the housing, and the acceleration of the housing comprises:
acquiring the pressure of the liquid outlet through a pressure sensor for each interval of a first preset period; and
the calculating the single operation periods of the valve box according to at least one of the pressure of the liquid outlet, the stress of the housing, and the acceleration of the housing comprising:
acquiring a start operation time and a stop operation time of the valve box according to the pressure of the liquid outlet; and
calculating a single operation period of the valve box according to the start operation time and the stop operation time of the valve box.

3. The method according to claim 2, wherein the acquiring the start operation time and the stop operation time of the valve box according to the pressure of the liquid outlet comprises:
continuously acquiring a plurality of pressures of an outlet to obtain a plurality of collecting points according to the continuous plurality of pressures of the liquid outlet and the first preset period; wherein collecting points comprise an acquiring time of the pressure of the liquid outlet and the pressure of the liquid outlet;
acquiring a pressure profile corresponding to the collecting points according to the plurality of collecting points;
acquiring a discrete curvature of each of the collecting points on the pressure profile; and
acquiring the start operation time and the stop operation time of the valve box according to the discrete curvature of each of the collecting points.

4. The method according to claim 3, wherein the acquiring the discrete curvature of each of the collecting points on the pressure profile comprises:
calculating the discrete curvature of each of the collecting points on the pressure profile according to a formula
$${K}_{i} = \frac{Δ {θ}_{i}}{Δ {L}_{i}} ;$$
wherein Kᵢ is the discrete curvature of the i-th collecting point;
$$Δ {θ}_{i} = arctan ( \frac{( {f}_{i} - {f}_{i + 2} ) ( {s}_{i} - {s}_{i - 2} ) - ( {f}_{i} - {f}_{i - 2} ) ( {s}_{i} - {s}_{i + 2} )}{1 + ( {s}_{i} - {s}_{i - 2} ) ( {s}_{i} - {s}_{i + 2} )} ) \\ Δ {L}_{i} = \sqrt{{( {s}_{i + 1} - {s}_{i} )}^{2} + {( {f}_{i + 1} - {f}_{i} )}^{2}} + \sqrt{{( {s}_{i} - {s}_{i - 1} )}^{2} + {( {f}_{i} - {f}_{i - 1} )}^{2}} ,$$
fᵢ is a pressure of the liquid outlet of the i-th collecting point; and sᵢ is the acquiring time of the pressure of the liquid outlet of the i-th collecting point.

5. The method according to claim 4, wherein before the acquiring the start operation time and the stop operation time of the valve box according to the discrete curvature of each of the collecting points, the method further comprises:
calibrating the discrete curvature according to a formula
$$δ {K}_{i} = \frac{{K}_{i - 1} + {K}_{i} + {K}_{i + 1}}{3} ,$$
wherein δKᵢ is a calibrated discrete curvature of the i-th collecting point.

6. The method according to claim 3, wherein the acquiring the start operation time and the stop operation time of the valve box according to the discrete curvature of each of the collecting points comprises:
defining the acquiring time corresponding to a first collecting point whose discrete curvature is greater than zero as the start operation time according to the discrete curvature of each of the collecting points;
defining the acquiring time corresponding to a collecting point with the largest discrete curvature as an end operation time along an acquiring time sequence of the pressures;
determining whether the end operation time meeting a preset condition; and
in response to determining that the end operation time meeting the preset condition, defining the acquiring time corresponding to the collecting point with the largest discrete curvature and a negative value as the stop operation time between the start operation time and the end operation time.

7. The method according to claim 6, wherein the preset condition comprises:
a time difference between the end operation time and the start operation time being greater than or equal to ten first preset periods and being less than or equal to three thousand first preset periods.

8. The method according to claim 1, wherein the acquiring at least one of the pressure of the liquid outlet, the stress of the housing, and the acceleration of the housing comprises:
acquiring the stress of the housing by a strain gauge sensor for each interval of a second preset period; or/and
acquiring the acceleration of the housing by an acceleration sensor for each interval of the second preset period;
the acquiring a start operation time and a stop operation time of the valve box according to at least one of the pressure of the liquid outlet, the stress of the housing, and the acceleration of the housing comprising:
calculating the single operation period of the valve box according to the stress of the housing; or/and
calculating the single operation period of the valve box according to the acceleration of the housing.

9. The method according to claim 8, wherein the calculating the single operation period of the valve box according to the stress of the housing comprises:
acquiring N continuous stresses of the housing to obtain a first stress data set;
performing a Fourier transform on the first stress data set to obtain a correspondence relationship between amplitudes and frequencies in the first stress data set;
determining whether the valve box is in an operation state according to the correspondence relationship between amplitudes and frequencies; and
calculating the single operation period of the valve box according to a duration of the valve box in the operation state in response to determining that the valve box is in the operation state.

10. The method according to claim 9, wherein the housing comprises a connecting hole for inserting a plunger;
the determining whether the valve box being in the operation state according to the correspondence relationship between the amplitudes and the frequencies comprising:
determining whether the correspondence relationship between the amplitudes and the frequencies comprising a first frequency corresponding to the valve box and a second frequency corresponding to the plunger; and
in response to determining that the correspondence relationship between the amplitudes and the frequencies comprising the first frequency and the second frequency, then the valve box is in the operation state.

11. The method according to claim 10, wherein after the determining whether the correspondence relationship between the amplitudes and the frequencies comprising the first frequency corresponding to the valve box and the second frequency corresponding to the plunger, the method further comprises:
outputting a determination result that the valve box is damaged in response to determining that in response to determining that the correspondence relationship between the amplitudes and the frequencies comprising the second frequency rather than the first frequency.

12. The method according to claim 9, wherein the calculating the single operation period of the valve box according to the duration of the valve box in the operation state in response to determining that the valve box being in the operation state comprises:
binding the first stress data set with a first label in response to determining that the valve box is in the operation state;
sequentially acquiring N continuous stresses of the housing to obtain M second stress data sets; wherein in a chronological order, a first second stress data set of the second stress data sets is shifted by the second preset period relative to the first stress data set, and a M-th second stress data set of the second stress data sets is shifted by the second preset period relative to a M−1-th second stress data set of the second stress data sets;
sequentially determining whether the valve box is in the operation state within a period corresponding to the second stress data set, and binding the second stress data set with a second label in response to determining that the valve box is in the operation state; and
calculating the single operation period of the valve box according to a number of the first label and the second label.

13. The method according to claim 12, wherein the calculating of the single operation period of the valve box according to the number of the first label and the second label comprises:
calculating the single operation period of the valve box according to a formula
Lᵥ=t₂×N+t₂×K;
wherein Lᵥ is the single operation period of the valve box; t₂ is the second preset period; and K is the number of the second label.

14. The method according to claim 12, wherein after the sequentially determining of whether the valve box being in the operation state within the period corresponding to the second stress data set, the method further comprises:
in response to determining that the valve box is not in the operation state, the calculating of the single operation period of the valve box is completed.

15. The method according to claim 8, wherein the calculating the single operation period of the valve box according to the acceleration of the housing comprises:
acquiring N continuous accelerations of the housing to obtain a first acceleration data set;
performing a Fourier transform on N of the first acceleration data sets to obtain a correspondence relationship between amplitudes and frequencies in the first acceleration data sets;
determining whether the valve box is in an operation state according to the correspondence relationship between the amplitudes and the frequencies; and
calculating the single operation period of the valve box according to a duration of the valve box in the operation state in response to determining that the valve box is in the operation state.

16. A system for inspecting an operation period of a valve box, comprising:
the valve box comprising a housing provided with a liquid outlet for discharging liquid;
at least one of a pressure sensor, a strain gauge sensor, and an acceleration sensor; the pressure sensor being provided at the liquid outlet to acquire pressure of the liquid outlet; the strain gauge sensor being connected to the housing to acquire stress of the housing; the acceleration sensor being connected to the housing to acquire acceleration of the housing; and
a computer apparatus connected to at least one of the pressure sensor, the strain gauge sensor, and the acceleration sensor to implement steps of the method according to claim 1.

17. A computer apparatus comprising a memory and a processor, the memory storing a computer program, wherein the processor implements steps of the method according to claim 1 when executing the computer program.

18. A computer readable storage medium in which a computer program is stored, wherein steps of the method according to claim 1 are implemented when the computer program is executed by a processor.
